(19) United States
(12) Patent Application Publication
(10) Pub. No.: US 2015/0052760 A1
(43) Pub. Date: Feb. 26, 2015

(54) Scooper for Food Products

(71) Applicant: Joel Keschner, Melville, NY (US)

(72) Inventor: Joel Keschner, Melville, NY (US)

(21) Appl. No.: 14/010,150

(22) Filed: Aug. 26, 2013

(51) Int. Cl. A47J 43/28

(52) U.S. Cl. CPC A47J 43/288
USPC 30/172

(57) ABSTRACT

A device for removing material from exposed areas of a food item, such as a bagel, and comprises an elongated handle coupled to a one end of a stem portion, the other end of the stem portion being coupled to a member having an array of three prongs extending therefrom. Each prong comprises an elongated member having rounded edges, the total width of the prong array being slightly less than the width of a typical sliced bagel thus preventing the circumference of the bagel from being cut during the scooping process.

### BACKGROUND OF THE INVENTION

1. Field of the Invention

The present invention provides a device for removing excess dough from the insides of various baked food products such as sliced bagels.

2. Description of the Prior Art

The capability of removing excess dough from the insides of bagels is something that appeals to people seeking to reduce the calorie count of the bagel (a plain bagel of medium size has been estimated to have 289 calories). An obvious way to remove the dough is by using one's fingers but this could result in unsanitary conditions.

U.S. Pat. No. 7,458,163 to Teich et al discloses a bagel scoop that removes excess dough from a piece of baked goods, such as bagel. The bagel scoop includes a handle and a spoon-shaped closed combined blade and scoop structure, having a downward curvature, to enable scooping and removal of dough. The outer end of the structure is serrated, to allow for scrapping and scooping of the bagel core dough at a leading edge of the blade. The combined blade and scoop structure is attached to a stem, which, in turn, is attached to the handle.

The serrated teeth on the blade and scoop structure end presents a safety issue for the user since the serrated teeth are sharp and cause inadvertent cuts in users during the scooping process. In addition, the width of the working surface of the scooper, although not disclosed, appears larger than the width of an average sliced bagel which may result in the outside edges of the bagel being cut during the scooping process.

What is thus desired is to provide a device for removing excess dough from the exposed surfaces of sliced baked products, such as bagels which is safer and more efficient than prior art bagel scoopers.

### SUMMARY OF THE INVENTION

The present invention provides a device for removing material from exposed areas of a food item. More particularly, the present invention provides a device for scooping out excess dough from the exposed surfaces of a sliced bagel.

The device comprises an elongated handle coupled to a one end of a stem portion, the other end of the stem portion being coupled to a member having an array of three prongs extending therefrom. Each prong comprises an elongated member having rounded edges, the total width of the prong array being slightly less than the width of a typical sliced bagel thus preventing the circumference of the bagel from being cut during the scooping process.

### DESCRIPTION OF THE DRAWINGS

For a better understanding of the present invention as well as other objects and further features thereof, reference is made to the following description which is to be read in conjunction with the accompanying drawing therein:

FIG. 1 illustrates a perspective view of the bagel scooper of the present invention; and

FIG. 2 is a view illustrating the prong array of the present invention.

### DESCRIPTION OF THE INVENTION

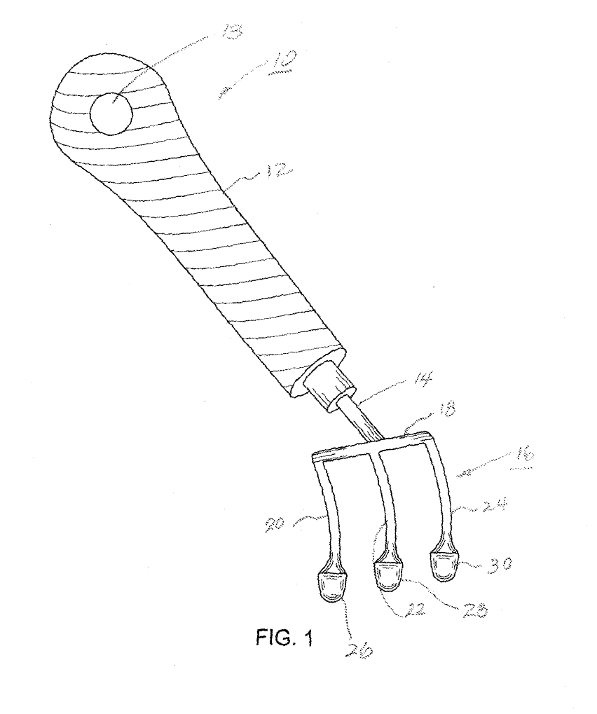

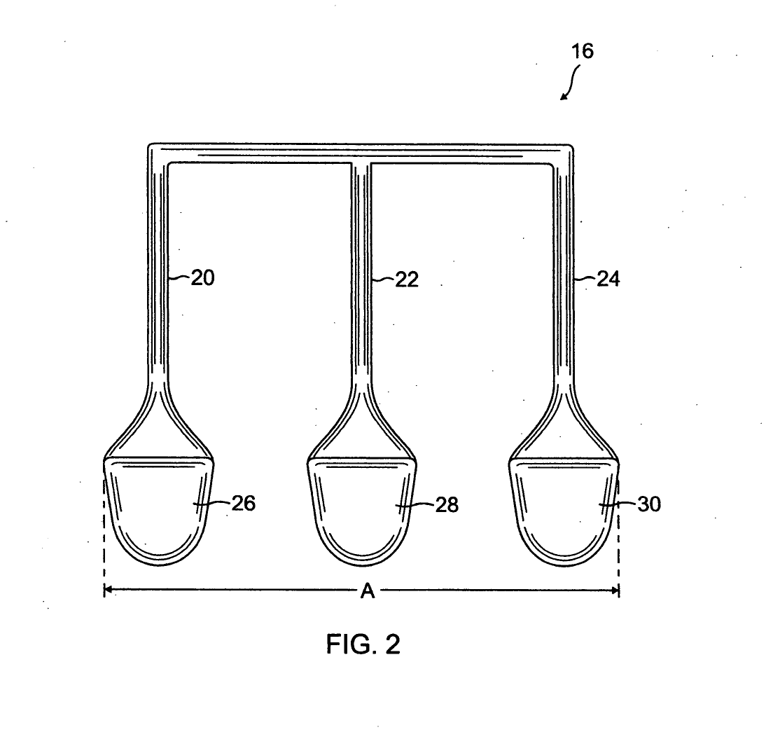

FIG. 1 is a perspective view of the device 10 of the present invention. Device 10 comprises handle 12 (preferably fabricated from metal) having an opening 13 formed therein, stem portion 14 and prong member 16. Prong member 16 includes a horizontal bar 18 and an array of prongs 20, 22 and 24. The prongs have rounded scooper edges 26, 28 and 30, respectively, formed on their far end and are preferably spaced apart ⅛ inch. The scooper edges have a spoon, or concave, shape to enable them to engage and remove excess dough from an exposed surface of a baked product, such as a bagel which has been sliced. The total width A (FIG. 2) of the pronged member 16 is selected to be slightly less than the width of an average sliced bagel, typically one-half inch. Limiting the width as noted prevents the circumference of the bagel from being cut during the scooping process. Opening 13 allows scooper 10 to be hung along with other kitchen utensils.

The rounded scooper edges 26, 28 and 30 and the general rounded surfaces of prong member 16 minimizes the chances that a user of the scooper 10 will be inadvertently cut during the scooping process.

The prong member 18 is positioned at an angle to stem portion as shown in FIG. 1, preferably at an angle of 60 degrees.

The scooping process is as follows (the process is described with reference to a bagel although dough from other baked food products can be also scooped out using scooper 18):

1. A whole bagel is sliced apart (note that the process can also be used with already sliced bagel halves) forming two bagel halves;

2. A selected bagel half is preferably positioned on a flat surface;

3. The user then grasps handle 12 and positions the prong member 18 above the bagel half; and

4. The user inserts the prong edges 26, 28 and 30 into the exposed dough at a predetermined depth and proceeds to pull handle 12 in the direction towards the user.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. A manually held device for removing excess dough from a food product comprising:
a longitudinally extending handle having a stem portion extending therefrom; and
said stem portion having a prong array extending away from paid stem portion; said prong array comprising a plurality of spaced-apart elongated members, the ends of said elongated members terminating in rounded, bowl shaped members.

2. The device of claim 1 wherein said array comprises three elongated members.

3. The device of claim 2 wherein said elongated members are spaced-apart approximately ⅛ inch.

4. The device of claim 3 wherein the width of said array is approximately ½ inch.
